(19) United States
(12) Patent Application Publication
(10) Pub. No.: US 2010/0225188 A1
(43) Pub. Date: Sep. 9, 2010

(54) AXLE GUIDE POSITIONING STRUCTRUE OF LINEAR ACTUATOR

(76) Inventor: Kuan-Shu TSENG, Xindian City (TW)

Correspondence Address: HDLS Patent & Trademark Services, P.O. BOX 220746, CHANTILLY, VA, 20153-0746, US

(21) Appl. No.: 12/400,252

(22) Filed: Mar. 9, 2009

(51) Int. Cl. H02K 7/10

(52) U.S. Cl. 310/83

(57) ABSTRACT

In an axle guide positioning structure of a linear actuator, the linear actuator includes a machine base, a motor fixed onto a side of the machine base, a cover covered onto the machine base and formed on another side of the motor, and the axle guide positioning structure includes an axle protruded from the motor and out of the machine base, a cylinder formed on the cover and disposed at a position corresponding to a free end of the axle, and a cap accommodated in the cylinder and sheathed to a free end of the axle, wherein a gap is formed between an external edge surface of the cap and an internal wall of the cylinder, and an adhesive is filled into the gap and solidified for a coupling effect. The axle guide positioning structure can effectively prevent the axle from being broken, cracked or damaged by lateral forces.

### BACKGROUND OF THE INVENTION

1. Field of the Invention

The present invention relates to an axle guide positioning structure, and more particularly to an axle guide positioning structure of a linear actuator.

2. Description of Prior Art

In a linear actuator, driving components such as a motor and a worm shaft and worm gear module are primarily used for driving a guide screw rod to rotate, while the guide screw rod is driven to linearly extend or retract a contractible tube screwed with the guild screw rod, and thus the linear actuator is used extensively in equipments such as hospital beds, electric power chairs, or many other areas that require a contracting or retreating movement. In general, the worm shaft of the linear actuator is nothing more than one extended directly from the motor shaft or connected to the motor shaft through a joint. The worm shaft (which is a motor shaft) has a free end formed at an end away from the motor for providing a single-side supporting effect when a relatively large torque is exerted onto the worm shaft during the transmission of the worm shaft and the worm gear. Therefore, the worm shaft may be broken or cracked very easily in a transmission process of engaging the worm gear, and it is an important subject of the present invention to improve the prior art.

To overcome the aforementioned problem of the conventional linear actuator, some manufacturers produce the motor shaft with a high-strength material, not only incurring a high cost, but also increasing the level of difficulty of the manufacturing procedure, and thus such products come with a high price and are not used extensively in the related industry. In general, a method as illustrated in FIG. 1 is used for manufacturing linear actuators, wherein a cover b disposed at a position corresponding to the top of the worm shape has a diameter much larger than a retaining hole c at a free end of the worm shaft, and the retaining hole c is provided for partially supporting the free end of the worm shaft, but this partial supporting method cannot solve the problem of the worm shaft that may be broken and cracked easily by lateral forces exerted onto the worm shaft. Obviously, the prior art requires further improvements.

### SUMMARY OF THE INVENTION

It is a primary objective of the present invention to provide an axle guide positioning structure of a linear actuator, wherein a free end of an axle can be supported stably by a cap to prevent the axle from being broken or cracked due to the lateral forces exerted onto the axle.

To achieve the foregoing objectives, the present invention provides an axle guide positioning structure of a linear actuator, and the linear actuator comprises a machine base fixed onto a motor on a side of the machine base, and a cover covered onto the machine base and formed on another side of the motor. The axle guide positioning structure comprises an axle protruded from the motor and passed out from the machine base, a cylinder formed on the cover and corresponding to a free end of the axle, and a cap accommodated in the cylinder and sheathed to a free end of the axle, wherein a gap is formed between the external edge surface of the cap and the internal wall of the cylinder, and an adhesive is filled into the gap and solidified for coupling the cap and the cylinder.

Compared with the prior art, the present invention has the following advantages and effects. Since the free end of the axle is fully supported by the cap, it no longer needs to manufacture the axle with a high-strength steel material, and thus greatly reducing the material cost and the manufacturing cost. With the internal ring formed on the internal wall of the cylinder for attaching and coupling the bottom of the cap, the liquid adhesive is blocked from flowing into the machine base during the process of filling the liquid adhesive in order to prevent the internal transmission components from being struck and failing to operate. The cap substantially in a conical shape allows the adhesive to be filled into the gap easily and increases the quantity of the filled adhesive. By building the coarse lines and grooves on the internal wall of the cylinder and the external peripheral surface of the cap, the present invention can increase the strength of coupling the cap with the cylinder after the adhesive is solidified.

### BRIEF DESCRIPTION OF DRAWINGS

FIG. 1 is a cross-sectional view of a conventional axle guide structure;

FIG. 2 is perspective view of a linear actuator in accordance with the present invention;

FIG. 3 is an exploded view of a linear actuator in accordance with the present invention;

FIG. 4 is a cross-sectional view of the present invention before an adhesive is filled;

FIG. 5 is a cross-sectional view with a partial enlarged portion of a guide positioning structure in accordance with the present invention; and

FIG. 6 is a cross-sectional view of a partial enlarged portion of a guide positioning structure in accordance with a preferred embodiment of the present invention.

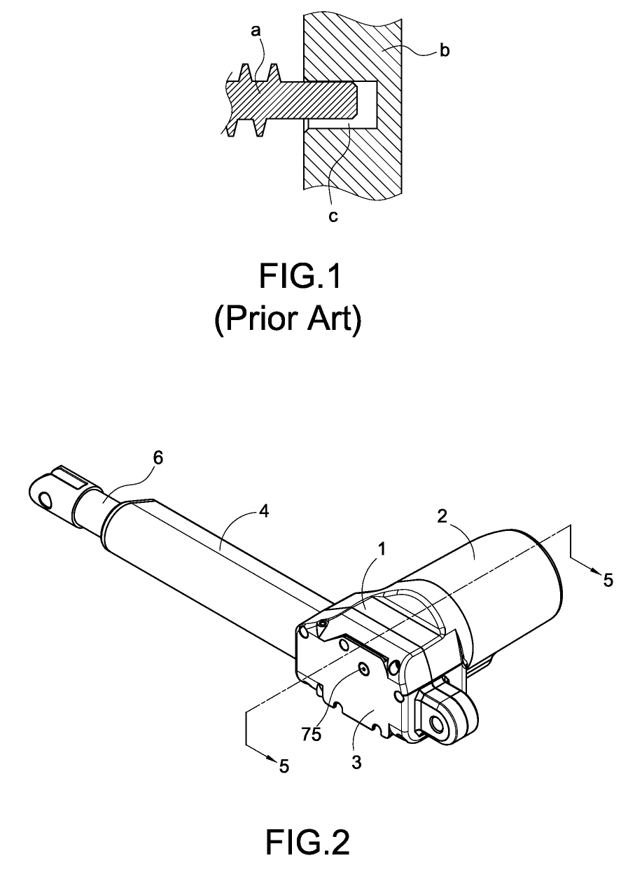

### DETAILED DESCRIPTION OF THE INVENTION

The technical characteristics, features and advantages of the present invention will become apparent in the following detailed description of preferred embodiments with reference to the accompanying drawings, and the preferred embodiments are used for illustrating the present invention only, but not intended to limit the scope of the invention.

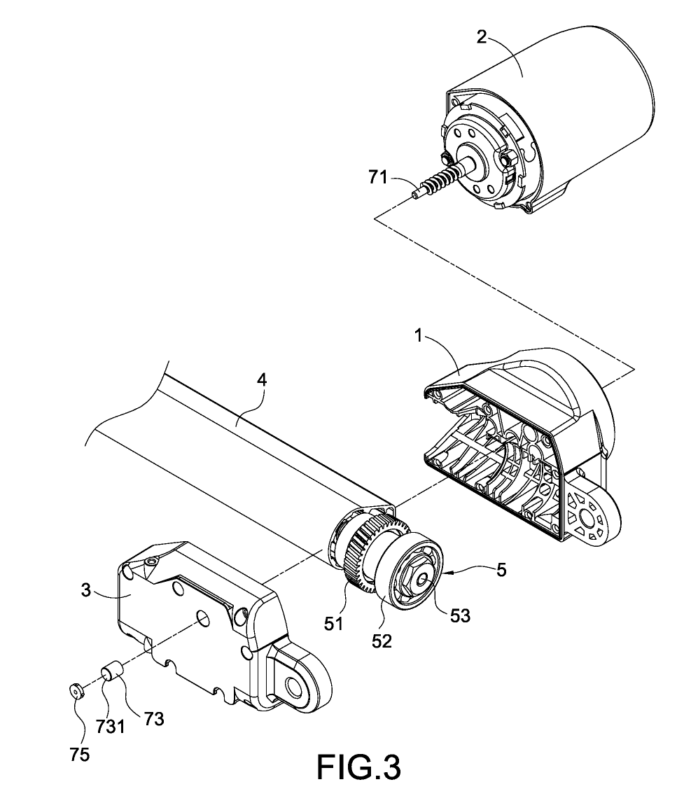

With reference to FIGS. 2 to 5 for an axle guide positioning structure of a linear actuator of the present invention, the linear actuator comprises a machine base 1, an electric motor 2, a cover 3, an external tube 4, a transmission mechanism 5 and a contractible rod 6, wherein the electric motor 2 is fixed to the bottom of the machine base 1, and the cover 3 is covered onto the top of the machine base 1, and the external tube 4 is clamped and fixed into a position by the cover 3 and the machine base 1 and disposed perpendicular to the electric motor 2. In addition, a transmission mechanism 5 comprised of a worm gear 51, a bearing 52 and a guide screw rod 53 is installed inside the cover 3 and the machine base 1, and a contractible rod 6 is accommodated in the external tube 4 and screwed with a guide screw rod (not shown in the figure) of the transmission mechanism 5, such that the contractible rod 6 can be extended or retracted linearly with respect to the external tube 4.

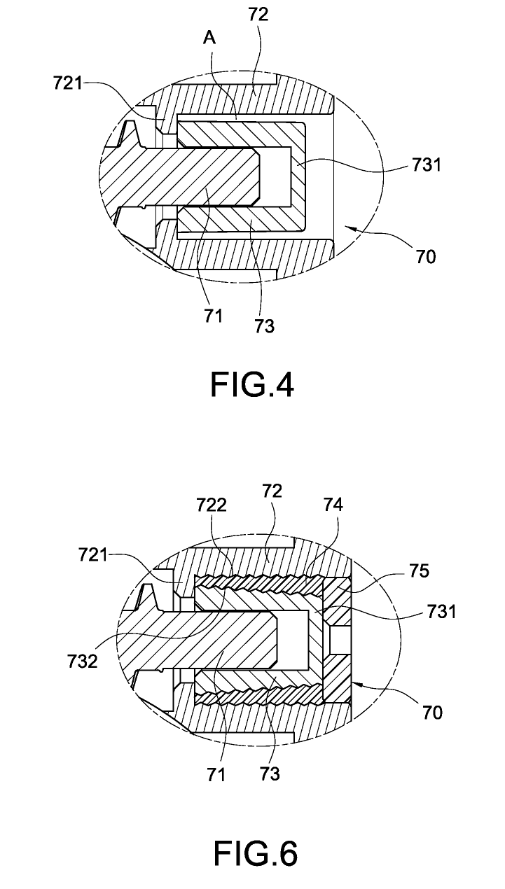

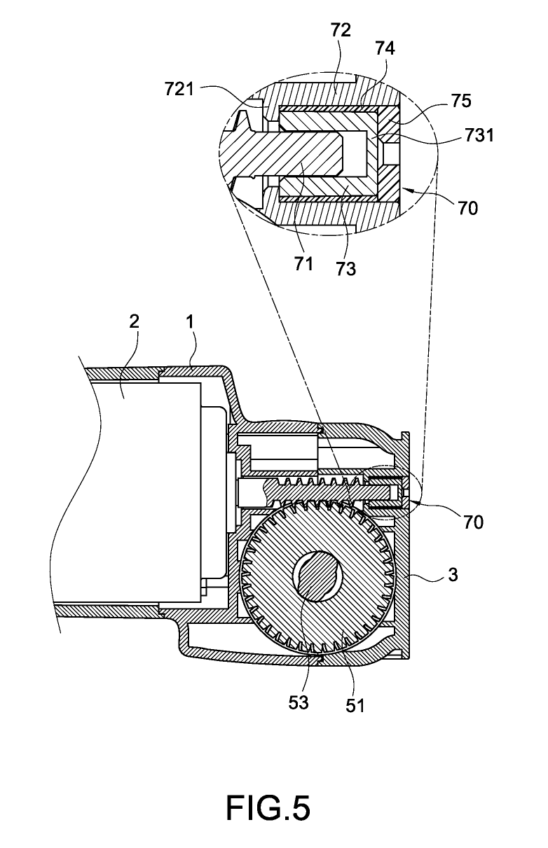

The axle guide positioning structure 70 of the present invention comprises an axle 71, a cylinder 72, a cap 73 and an adhesive 74, wherein the axle 71 is protruded from the center of the electric motor 20 and passed out from the machine base 1, and the axle 71 of this preferred embodiment is a worm shaft engaged with the worm gear 51 of the transmission mechanism 5, and the cylinder 72 is formed at the cover 30 and disposed at a position corresponding to a free end of the axle 71, and the cylinder 72 of this preferred embodiment has an internal ring 721 protruded from an internal wall of the cylinder 72, and the cap 73 is in a cylindrical shape with a seal end 731 and accommodated in the cylinder 72 and sheathed to the free end of the axle 71, and the bottom of the cap 73 is attached and contacted with the top of the internal ring 721, and a gap A (as shown in FIG. 4) is formed between the external edge surface of the cap 73 and the internal wall of the cylinder 72, and the adhesive 74 is filled into gap A for coupling the cap 73 with the cylinder 72 after the adhesive 74 is solidified (as shown in FIG. 5).

The axle guide positioning structure 70 of the present invention further comprises a plug 75 pressed and engaged into the cylinder 31 and formed at the top of the cap 73. In a continuous production process, the adhesive 74 is prevented from overflowing before the adhesive 74 is solidified, in order to enhance the production rate and the production performance.

With reference to FIG. 6 for a partial enlarged view of a guide positioning structure in accordance with another preferred embodiment of the present invention, the axle guide positioning structure 70 of the present invention can be implemented by the mode of the aforementioned preferred embodiment or this preferred embodiment, wherein the diameter of the cylindrical shape cap 73 is tapered towards the seal end 731 of the cap 73 for facilitating the filling of the adhesive 74 and increasing the quantity of filled adhesive 74. In addition, one or more coarse lines 732 (not shown in the figure) are formed on an external edge surface of the cap 73 by a stamping method. Similarly, one or more grooves 722 with etched marks (not shown in the figure) are formed on the internal wall of the cylinder 72 to increase the strength of coupling the adhesive 74, the cylinder 72 and the cap 73.

In summation of the description above, the axle guide positioning structure of a linear actuator of the invention can achieve the expected objectives and overcome the shortcomings of the prior art. The invention complies with the requirements of patent application and is thus duly filed for patent application. While the invention has been described by means of specific embodiments, numerous modifications and variations could be made thereto by those skilled in the art without departing from the scope and spirit of the invention set forth in the claims.

What is claimed is:

1. An axle guide positioning structure of a linear actuator, and the linear actuator comprising:
a machine base fixed onto a motor on a side of the machine base, and a cover covered onto the machine base and formed on another side of the motor, and the axle guide positioning structure comprising an axle protruded from the motor and passed out from the machine base, a cylinder formed on the cover and at a position corresponding to a free end of the axle, and a cap accommodated in the cylinder and sheathed onto a free end of the axle, wherein a gap is formed between an external edge surface of the cap and an internal wall of the cylinder, and an adhesive is filled into the gap and solidified for coupling the cap and the cylinder.

2. The axle guide positioning structure of a linear actuator as recited in claim 1, wherein the cylinder includes an internal ring extended from the internal wall of the cylinder, and the bottom edge of the cap is attached and sealed onto the internal ring.

3. The axle guide positioning structure of a linear actuator as recited in claim 1, wherein the cap is in a cylindrical shape with a seal end, and the external diameter of the cap is tapered towards the seal end.

4. The axle guide positioning structure of a linear actuator as recited in claim 1, wherein the cap includes a coarse line formed on the external edge surface of the cap and coupled with the solidified adhesive.

5. The axle guide positioning structure of a linear actuator as recited in claim 1, wherein the cylinder includes a groove formed on the internal wall of the cylinder and coupled with the solidified adhesive.

6. The axle guide positioning structure of a linear actuator as recited in claim 1, wherein the cap includes a plurality of coarse lines disposed on the external edge surface of the cap and coupled with the solidified adhesive.

7. The axle guide positioning structure of a linear actuator as recited in claim 1, wherein the cylinder includes a plurality of grooves formed on the internal wall of cylinder and coupled with the solidified adhesive.

8. The axle guide positioning structure of a linear actuator as recited in claim 1, further comprising a plug pressed and sealed in the cylinder and formed at the top of the cap.
